(19) United States
(12) Patent Application Publication
(10) Pub. No.: US 2010/0031180 A1
(43) Pub. Date: Feb. 4, 2010

(54) METHOD FOR INDICATING THE AMOUNT OF COMMUNICATION FOR EACH USER USING THE ICON AND COMMUNICATION TERMINAL USING THE SAME

(75) Inventors: Yong-Su Shin, Seoul (KR); Dongjun Lee, Gyeonggi-do (KR)

Correspondence Address: Muncy, Geissler, Olds & Lowe, PLLC, P.O. BOX 1364, FAIRFAX, VA, 22038-1364, US

(73) Assignee: NEO IRIS, INC., SEOUL (KR)

(21) Appl. No.: 12/519,269

(22) PCT Filed: Dec. 13, 2007
(86) PCT No.: PCT/KR07/06505

§ 371 Date: Jun. 15, 2009

(30) Foreign Application Priority Data
Dec. 13, 2006 (KR) 10-2006-0127012

(51) Int. Cl. G06F 3/048; G06F 15/16

(52) U.S. Cl. 715/771; 709/206; 715/810

(57) ABSTRACT

A method of displaying a communication amount of each user using an icon and a communication terminal using the method are provided. An icon having a shape which can be changed according to the communication amount between a communication terminal user and a communication counterparty is registered, the shape of icon is updated according to the communication amount every predetermined time period, and the icon is displayed to the user. Accordingly, the user can intuitively recognize the communication amount with respect to the communication counterparty.

### TECHNICAL FIELD

The present invention relates to a method of displaying a communication amount between users in a mobile apparatus or an instant messaging program and a communication terminal using the method. More particularly, the present invention relates to a method of displaying a communication amount between users recorded in a phone number list of a mobile apparatus or between communication counterparties recorded in an instant messaging program by using a shape-changeable icon and a mobile apparatus or a communication terminal with the instant message program executed therein by using the method.

### BACKGROUND ART

As IT technologies are rapidly developed, mobile communication terminals such as a mobile phone and a personal data assistant (PDA) are widely used. Due to their convenience of communication, the mobile communication terminals are used as necessities of modern life. In the business and private life of modem men, the mobile communication terminals are more widely used instead of wire telephones. In addition, frequency of phone calls or SMS messages is used as a standard for determining a degree of intimacy of business or private human relationship.

In a conventional mobile communication terminal, a user stores communication times with respect to communication counterparties, a recent receiving call list, and a recent transmitting call list. If the calls in the list exceed a predetermined number, older receiving and transmitting call histories are designed to be sequentially removed from a memory.

Therefore, the user cannot know the frequency of communication with respect to a counterparty registered in a phone number list of the mobile communication terminal. Accordingly, the user searches for the receiving call list and the transmitting call list temporarily stored in the memory so as to roughly know the frequency of communication with respect to the specific counterparty and how many times the counterparty makes a phone call.

In particular, the user of the mobile communication terminal has a general tendency to frequently communicate with only the counterparties who frequently make a phone call. Once the user has no communication with a specific counterparty for a long time, the human relationship therein may be gradually estranged. In the conventional mobile communication terminal, since only the predetermined number of recent receiving and transmitting call lists are displayed to the user, there is a problem in that the user cannot suitably regionalize to-be-estranged relationship in advance.

Such a problem also occurs in instant messaging program which are used by many people on the Web. The currently-used instant messaging program such as the MSN messenger and Nate-On messenger provides only the functions of allowing the users to register communication counterparties and transmit messages to the registered communication counterparties and to receive messages from the registered communication counterparties and display the messages to the user. That is, the conventional instant messaging program cannot provide function of allowing the user to manage the frequency of communication and the communication time amount. Therefore, the user may unintentionally have no communication with a registered communication counterparty, so that the human relationship to the communication counterparty may be estranged.

### DISCLOSURE OF INVENTION

### Technical Problem

The present invention provides a method of displaying a communication amount of each user, which is adopted to a mobile communication terminal and an instant messaging service to perspicuously display the communication amount with respect to a counterparty registered in a phone number list or a communication counterparty list by using an icon.

The present invention relates to a mobile communication terminal or a user terminal apparatus with an instant messaging program installed therein, capable of perspicuously display the communication amount with respect to a counterparty registered in a phone number list or a communication counterparty list by using the method of displaying a communication amount of each user.

### Technical Solution

According to an aspect of the present invention, there is provided a communication terminal comprising: a display unit which displays a list of communication counterparties together with an icon of an icon-registered communication counterparty among the communication counterparties in the list; a storage unit which stores registered-icon identification information of the communication counterparty, image information of each level of icon, level determination information for defining a level determination scheme for the icon, and detailed communication history information representing a communication amount to the communication counterparty; and a central controller which determines the level of icon according to the level determination information and the communication amount transmitted/received to/from a user terminal of the communication counterparty and outputs the image information of the icon corresponding to the level of icon to the display unit.

In addition, the central controller updates the detailed communication history information according the communication amount transmitted/received from/to the user terminal of the communication counterparty and stores the detailed communication history information to the storage unit, wherein the central controller determines the level of icon by using the detailed communication history information and stores the level of icon, and wherein the central controller outputs the image information of the icon corresponding to the level of icon to the display unit.

In addition, the level determination information defines the level determination scheme for the icon by using the detailed communication history information, and wherein the central controller calculates a level score by allocating different scores to a communication data received from the user terminal of the communication counterparty and a communication data transmitted to the user terminal of the communication counterparty according to the level determination information and determines the level of icon according to the level score.

In addition, the level determination information defines the level determination scheme for the icon by using the detailed communication history information, and wherein the central controller calculates a level score by allocating different scores to a phone communication data, an SMS message, an MMS message, and an instant message received/transmitted from/to the user terminal of the communication counterparty according to the level determination information and determines the level of icon according to the level score.

In addition, the detailed communication history information includes at least one of a total number of communication times, a total number of transmitting times, a total number of receiving times, total communication time amount, a total transmitting time amount, a total receiving time amount, a recent transmitting date, a recent receiving date, weekday/week/month-based communication times and communication amount, and existence of transmitting/receiving history with respect to the communication counterparty, and wherein the central controller outputs to the display unit the detailed communication history information in accordance with user's selection.

In addition, the central controller updates the communication amount with respect to the icon-registered communication counterparty according to an automatic update time period information included in the level determination information, updates the level of icon according to the updated communication amount, and displays icon image information corresponding to the updated level of icon to the user.

According to another aspect of the present invention, there is provided a method of displaying a communication amount of each user on a communication terminal implemented with a mobile communication terminal or a computer, the method comprising steps of: (a) registering an icon of which shape is changed according to the communication amount with respect to the communication counterparty in a phone number list or a communication counterparty list registered in the communication terminal; (b) performing communication by transmitting a phone call or a predetermined-format message to a user terminal of the communication counterparty or receiving the phone call or the predetermined-format message from the user terminal of the communication counterparty; (c) recording a communication history with respect to the communication counterparty and updating detailed communication history information with respect to the communication counterparty to determine a level of icon; and (d) displaying an icon image having a shape corresponding to the level of icon to the user.

In addition, the detailed communication history information includes at least one of a total number of communication times, a total number of transmitting times, a total number of receiving times, total communication time amount, a total transmitting time amount, a total receiving time amount, a recent transmitting date, a recent receiving date, weekday/week/month-based communication times and communication amount, and existence of transmitting/receiving history with respect to the communication counterparty, and wherein in the step (c), a predetermined score is allocated to each item in the detailed communication history information to calculate a level score, and the level of icon is determined according to the level score.

In addition, in the step (c), different scores are allocated to different types of a communication data received from a user terminal of the communication counterparty and a communication data transmitted to the user terminal of the communication counterparty to calculate the level score, and the level of icon is determined according to the level score.

In addition, the detailed communication history information includes at least one of a total number of communication times, a total number of transmitting times, a total number of receiving times, total communication time amount, a total transmitting time amount, a total receiving time amount, a recent transmitting date, a recent receiving date, weekday/week/month-based communication times and communication amount, and existence of transmitting/receiving history with respect to the communication counterparty, and wherein the method further comprises a step of outputting to the user the detailed communication history information in accordance with user's selection.

In addition, in the step (a), icon-level-based image information, level determination information for defining an icon level determination scheme and a level update time period, and identification information for representing a communication counterparty to which the icon is registered are downloaded from a predetermined icon providing server, and the icon of the counterparty represented by the identification information is registered.

In addition, the method further comprises a step of updating the level of icon according to the level determination information every level update time period.

According to still another aspect of the present invention, there is provided a method of displaying a communication amount of each user, the method comprising steps of: a first user terminal accessing a predetermined icon providing server, selecting an icon which is to be transmitted to a second user terminal, and completing payment for the icon; the icon providing server downloading to the second user terminal the icon selected by the first user terminal together with identification information of the first user terminal; the second user terminal identifying the first user according to the identification information and registering the icon in association with the first user; the second user terminal recording a communication history and updating detailed communication history information during communication with the first user terminal; and the second user terminal updating the level of icon according to the detailed communication history information and displaying to the second user terminal the icon having a shape corresponding to the level of icon in association with the first user.

In addition, the method further comprises a steps of updating the detailed communication information every predetermined time period, updating and storing the level of icon according to the detailed communication history information, and displaying the second user the icon having a shape corresponding to the updated level of icon in association with the first user.

### Advantageous Effects

As described above, according to the present invention, an icon having a shape which can be changed according to the communication amount between a communication terminal user and a communication counterparty is registered, the shape of icon is updated according to the communication amount every predetermined time period, and the icon is displayed to the user. Accordingly, the user can intuitively recognize the communication amount with respect to the communication counterparty.

In addition, according to the present invention, a conventional method of displaying a phone number list, a call history, a communication counterparty list and the like in a monotonous manner can be reformed into an interesting method by using various icons. In addition, a user can directly download a desired icon through a Web service and allocate the icon to a desired communication counterparty, so that it is possible to implement a new icon usage pattern in which the icons can be registered and used between the user and the frequently-contacting counterparties such friends, lovers, and family members.

### BRIEF DESCRIPTION OF THE DRAWINGS

FIG. 1 is a view illustrating a configuration of a whole system in which a user terminal and an icon providing server are connected to each other via wire/wireless communication network, according to a preferred embodiment.

FIG. 2 is a block diagram illustrating a configuration of user terminals 100 and 200 according to the preferred embodiment of the present invention.

FIG. 3 is a flowchart for explaining an icon registration process according to the preferred embodiment of the present invention.

FIG. 4 is a flowchart illustrating processes of an icon management method according to the preferred embodiment of the present invention in a case where the user terminal is a mobile communication terminal.

FIGS. 5 to 8 are views illustrating an example of a method of displaying a communication amount of each user in a user terminal that is a mobile communication terminal.

FIG. 9 is a flowchart for explaining a method of displaying a communication amount of each user according to the present invention in a case where a user terminal is a computer with a messenger program installed therein.

FIGS. 10 to 13 are views illustrating an example of a method of displaying a communication amount of each user in a user terminal that is a computer with a messenger program installed therein.

### BEST MODE FOR CARRYING OUT THE INVENTION

Hereinafter, preferred embodiments of the present invention will be described with reference to the accompanying drawings.

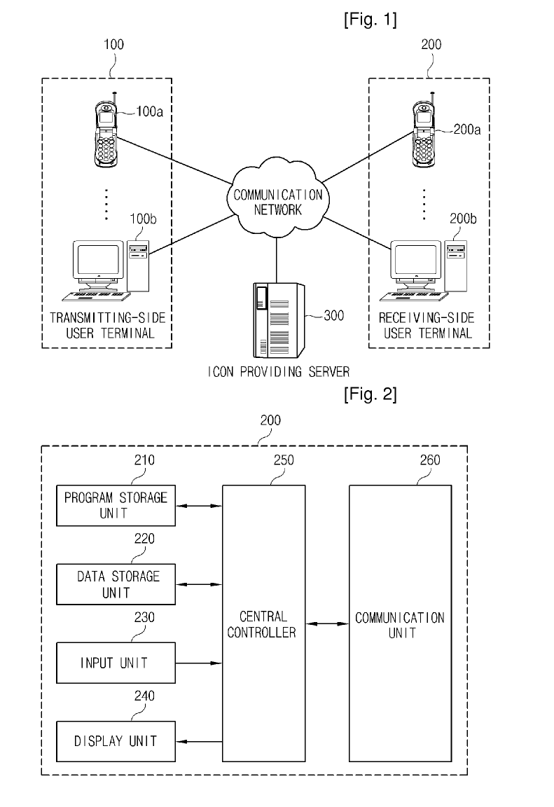

FIG. 1 is a view illustrating a configuration of a whole system in which a user terminal and an icon providing server are connected to each other via wire/wireless communication network, according to a preferred embodiment.

Referring to FIG. 1, a whole system according to the present invention includes a plurality of user terminals 100 and 200 and an icon providing server 300. The user terminals 100 and 200 and the icon providing server 300 are connected to each other via wire/wireless communication network.

The user terminals 100 and 200 may be mobile communication terminals 100a and 200a such a mobile phone or a PDA with a wireless LAN provided thereto or terminals 100b and 200b with an instant messaging program installed therein such as a desktop PC, a notebook PC, an UMPC, or a PDA. The user terminals 100 and 200 include a transmitting-side user terminal 100 which makes a phone call, transmits an SMS or MMS message, or transmits an instant message to a receiving-side terminal 200 and a receiving-side terminal 200 which receives a phone call or a message from the transmitting-side terminal 100.

The icon providing server 300 stores icons that are to be installed and displayed in a user terminal and an icon management program and downloads the icons and the icon management program to the accessed user terminal(s) 200 via the wire/wireless communication network.

In the preferred embodiment of the present invention, when the user terminal 100 accesses the icon providing server 300 via the wire/wireless communication network and completes payment of the downloading of icon, the icon providing server 300 downloads user information (phone number or user ID) of the icon-transmitting user, the icon, and the icon management program to the receiving-side terminal 200 according to the phone number of user ID designated by the transmitting-side user terminal 100.

Next, the user terminal 200 installs the icon management program therein and registers the received icon in association with the phone number or user ID of the icon-transmitting user, stores information (a phone call history, an SMS/MMS message transmitting/receiving history, and an instant message transmitting/receiving history) of a communication amount between the icon-receiving user terminal and the icon-transmitting user terminal during an icon valid time period, and displays a shape-changed icon in a recent communication list, a phone number list, an address list, a communication counterparty list according to the communication amount. Due to the displayed icon, the user can intuitively recognize the communication amount with respect to the counterparty in view of the shape of the icon. In addition, detailed communication history information may be displayed to the user in accordance with user's selection.

FIG. 2 is a block diagram illustrating a configuration of the user terminals according to the preferred embodiment of the present invention. Referring to FIG. 2, a configuration the receiving-side user terminal 200 as a reprehensive one of the user terminals is illustrated. The user terminal 200 includes a program storage unit 210, a data storage unit 220, a central controller 250, an input unit 230, a display unit 240, a communication unit 260, and the like.

The program storage unit 210 stores various types of software including an operating system (OS) for operating the user terminal 100 or 200. Particularly, in a case where the user terminals 100 and 200 are mobile communication terminals 100a and 200a, the program storage unit stores call process software for performing functions associated with a call process of the user terminals and various types of software for performing basic functions of a mobile phone or the like. In a case where the user terminal 100 and 200 are desktop PCs 100b and 200b, the program storage unit stores an instant messenger program and various programs.

In addition, the program storage unit 210 stores icon information, icon image information, and an icon management program that are downloaded from the icon providing server 300 to the user terminal according to the preferred embodiment of the present invention.

The icon information includes icon identification information (icon ID), level determination information, level-based icon shape identification information (icon shape ID), and icon valid time period information of the whole registered icons of users registered in the phone number list or the communication counter party list of the user terminal.

The level determination information is information for defining updating scheme information representing a standard for changing the level of icon according to the communication history (for example, a communication type (a phone call, an SMS/MMS message, an instant message, or the like), a communication time amount, a communication time interval (an time interval between a previous communication and a current communication), existence of transmitting/receiving history, and the like) with respect to the icon-registered counterparty and automatic update time period information representing a time period for automatically updating the level of icon.

The updating scheme information in the level determination information is information of a method of classifying the levels of icons into a predetermined number of levels (for example, 5 levels) and calculating a level score by using the communication histories with respect to the counterparty. That is, the updating scheme information is information representing correspondence of the level scores to the levels of icons.

The level determination information may be defined to calculate the level scores by allocating different level scores according to types of communication data (a phone call, an SMS message, an MMS message, and the like) and existence of transmitting/receiving history. For example, in a level score calculation scheme, when a user makes the phone call to a counterparty, a level score of +10 may be allocated; when the user transmits the SMS message, a level score of +2 may be allocated; when the user receives the phone call from the counterparty, a level score of +5 may be allocated; and when the user receives the SMS message from the counterparty, a level score of +1 may be allocated. In addition, a weight factor may also be allocated according to one or more standards of communication time interval, existence of recent communication, and a communication time amount so as to calculate the level score. The level may be determined according to a score range in which a sum of the level scores is included. Such a level score calculation process is performed by the later-described central controller 250.

The automatic update time period information in the level determination information represents a time period for automatically updating the level of icon if there is no communication to the icon-registered counterparty for a predetermined time period. The automatic update time period may be set so as for the level of icon to be automatically updated when a predetermine time (for example, one week, ten days, one month, or the like) elapses from the time point of the last phone or the time point of the last automatic updating.

The icon image information includes an image data representing IDs and icon shapes of the level of icon.

When the user terminal is driven, the icon management program is loaded on the central controller 250 and executed in the central controller 250. Detailed functions of the icon management program will be described in association with the later-described central controller 250.

The data storage unit 220 may be constructed with a volatile memory such as a RAM or a non-volatile memory such as a flash memory. The data storage unit stores various types of data generated in the user terminal. More specifically, the data storage unit 200 stores data such as a total communication time amount, a phone number list or a communication counterparty list, messages received by a user terminal, message transmitted by the user terminal, a recent communication history, and a recent calling history as general functions of a mobile communication terminal.

The data storage unit 220 stores icon management information of each user according to the present invention. The icon management information includes basic information such as IDs, names, and phone numbers of the icon-registered counterparties, icon identification information (icon ID), a current level score, a highest level score, a lowest level score, a current icon level information, an icon valid time period, and the like of an icon allocated to an counterparty. In addition, the data storage unit 220 stores detailed communication history information including time/day/month/weekday-based communication histories and a message transmitting/receiving history. Alternatively, the icon management information and the detailed communication history information may be stored in the program storage unit.

In a case where the user terminal is a mobile communication terminal, the input unit 230 may be constructed with a keypad, a touch screen, or the like. In a case where the user terminal is a notebook PC, or a desktop PC, the input unit 230 may be constructed with a keyboard, a mouse, or the like. Functions of the input unit 230 are the same as those of a general mobile phone or a general computer, and thus detailed description thereof is omitted.

The display unit 240 may be constructed with an LCD panel, a CRT, or the like. In case of a mobile communication terminal, the display unit displays whole operation states of the mobile communication terminal such as a usage of power supply, a reception intensity of electric wave, and date/time. The display unit 240 displays to the user the icon of each user and the detailed communication history information of each user according to the preferred embodiment of the present invention as well as information output from a general mobile communication terminal or a general PC.

The communication unit 260 converts signals received via a wire/wireless communication network and outputs the converted signals to the central controller 250. The communication unit converts signals input by the central controller 250 and transmits the converted signals via the wire/wireless communication network.

More specifically, in a case where the user terminal is a computer, the communication unit converts data signals input by the central controller 250 according to a predetermined protocol and transmits the converted data signals via the communication network. The communication unit converts data signals received via the communication network and outputs the converted data signals to the central controller 250.

In a case where the user terminal is a mobile communication terminal, the communication unit demodulates analog signals received via the wireless communication network, converts the analog signals to digital signals, and outputs the digital signals to the central controller 250. The communication unit 250 converts and modulates digital signals and transmits the modulated signals via the wireless communication network.

The central controller 250 controls whole functions of the aforementioned components. According to the preferred embodiment of the present invention, the central controller 250 checks the detailed communication history information with respect to the icon-registered counterparty of which icon is registered through loading of the icon management program, calculates the level score according to the detailed communication history information, and displays the icon having the shape corresponding to the determined level of icon in the phone number list or the communication counterparty list.

More specifically, the central controller 250 downloads from the icon providing server 300 the icon and the phone number or the counterparty identification information (counterparty ID) to which the icon is to be registered. If the phone number or the counterparty ID is registered in advance, the icon is registered in association with the phone number or the counterparty ID. If the phone number or the counterparty ID is not registered in advance, the phone number or the counterparty ID is registered in the phone number list or the communication counterparty list, and after that, the icon is registered in association with the phone number or the counterparty ID.

The icon includes a plurality of image data corresponding to the levels. For example, in case of an potted-flower icon, the image data includes a shape of full bloom flower (level 5), a shape of slightly-withered flower (level 3), a shape of heavily withered flower (level 3), a shape of dead flower (level 2), and a shape of broken pot according to the levels. In addition, the icon image may be changed according to a contact frequency. As the contact frequency is higher and higher, the level becomes increased, and the icon image becomes a glowing flame icon. As the contact frequency is lower and lower, the level becomes decreased, and the icon image becomes a crying man icon representing that a man is lying face down and crying.

Next, in a case where a call or a message is received/transmitted from/to the icon-registered counterparty, the central controller 250 updates the aforementioned detailed communication history information (for example, a total number of communication time, a total number of transmitting times, a total number of receiving times, a total communication time amount, a total transmitting time amount, a total receiving time amount, a recent transmitting date, a recent receiving date, weekday/week/month-based communication times and communication amount, existence of transmitting/receiving history, and the like with respect to the counterpart), the level score, and the level of icon included in the level determination information according to the communication history with respect to the counterparty as defined in the updating scheme information in the level determination information. If there is a change in the level, the icon shape corresponding to the change in the level is displayed.

The central controller 250 allows the display unit to display to the user the detailed communication history information included in the level determination information in response to a user's request.

In addition, the central controller 250 updates the communication amount every predetermined time period according to the automatic update time period information included in the level determination information, updates the level of icon, and outputs to the user the icon image information corresponding to the updated level of icon. That is, the central controller 250 updates the communication time interval with respect to the icon-registered counterparty every time period represented by the automatic update time period information, changes the level score and the level of icon according to the updated communication time interval, and displays to the user the icon image corresponding to the changed level of icon.

In addition, the central controller 250 receives a checking condition associated with the level determination information as an input from the user and extracts a list of counterparties satisfying the condition from the data storage unit and outputs the list. The checking condition input from the user through the input unit relates to information that can be extracted in a direct manner or in a combination manner from the information included in the communication history including a counter party having the lowest transmitting communication amount or transmitting message amount during a predetermined time period, a counter party having the lowest receiving communication amount or receiving message amount during a predetermined time period, a counterparty having a longest communication or message transmitting/receiving time interval, and a counterparty having a communication amount equal to or less than a predetermined reference communication amount.

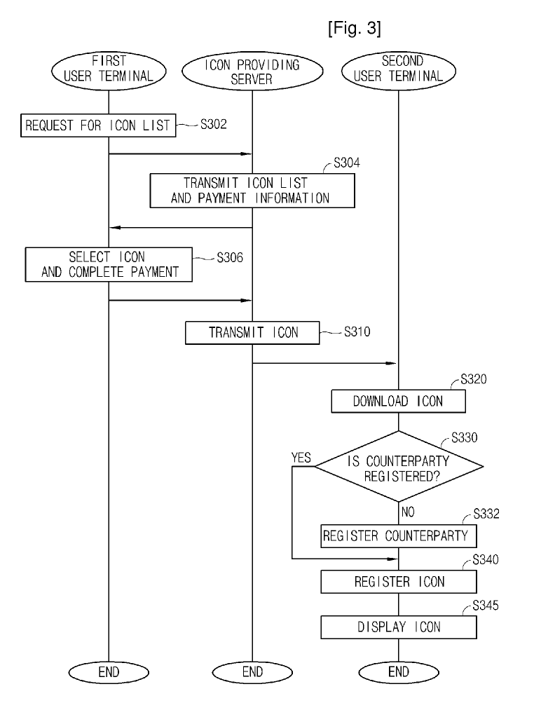

Hereinbefore, the configuration and functions of the user terminal according to the preferred embodiment of the present invention are described. Hereinafter, a method of displaying communication amount of each user by using the icon according to the present invention will be described with reference to FIGS. 3 to 13.

FIG. 3 is a flowchart for explaining an icon registration process according to the preferred embodiment of the present invention. Referring to FIG. 3, one user terminal (first user terminal) among user terminals accesses an icon providing server 300 via a wire/wireless communication network and requests for an icon list (S302). The icon providing server 300 transmits a current downloadable icon list and payment information to the first user terminal (S304). The first user terminal that receives the icon list and the payment information transmits to the icon providing server 300 information of a selected icon and identification information (phone number of user ID) of a user terminal (second user terminal) of a counterparty to whom the icon is to be transmitted and completes payment for the selected icon (S306).

When the payment for the icon is completed, the icon providing server 300 transmits the selected icon to the second user terminal (S310), and the second user terminal downloads the icon from the icon providing server 300 (S320).

The detailed configurations of the steps S310 and S320 may be implemented in various manners according to the types of the second user terminal.

For example, in a case where the second user terminal is a mobile communication terminal, the icon providing server 300 transmits an SMS message including a Call Back URL to the second user terminal, and the second user terminal access the icon providing server 300 via a wireless communication network and downloads the icon.

In a case where the second user terminal is a computer with a messenger program driven therein, the icon providing server 300 notifies to the second user terminal through a messenger update or a short message that the first user transmits the icon, and when requesting for icon transmission, the second user terminal downloads the icon.

At this time, in a case where the icon management program is not installed in the second user terminal, the icon management program, the icon data, and the ID number of the first user terminal that transmits the icon are downloaded to the second user terminal, and the icon management program is installed.

In a case where the icon management program is embedded in the second user terminal, or in a case where the icon management program is installed in the second user terminal in advance, the icon data and the ID number of the first user terminal that transmits the icon are downloaded to the second user terminal.

When the icon is downloaded, the second user terminal checks the identification information (phone number of user ID) of the first user terminal. If the counterparty is registered in advance, the method proceeds to a later-described step S340 (S330). If the counterparty (first user terminal) that transmits the icon is not registered in the phone number list or the communication counterparty list of the second user terminal, the counterparty is registered in the phone number list or the communication counterparty (S332).

When the counterparty is registered, the second user terminal registers the downloaded icon in association with the phone number or user ID of the counterparty (S340). An icon shape of the counterparty corresponding to an initial level of the icon is displayed in association with the phone number or user ID (S345).

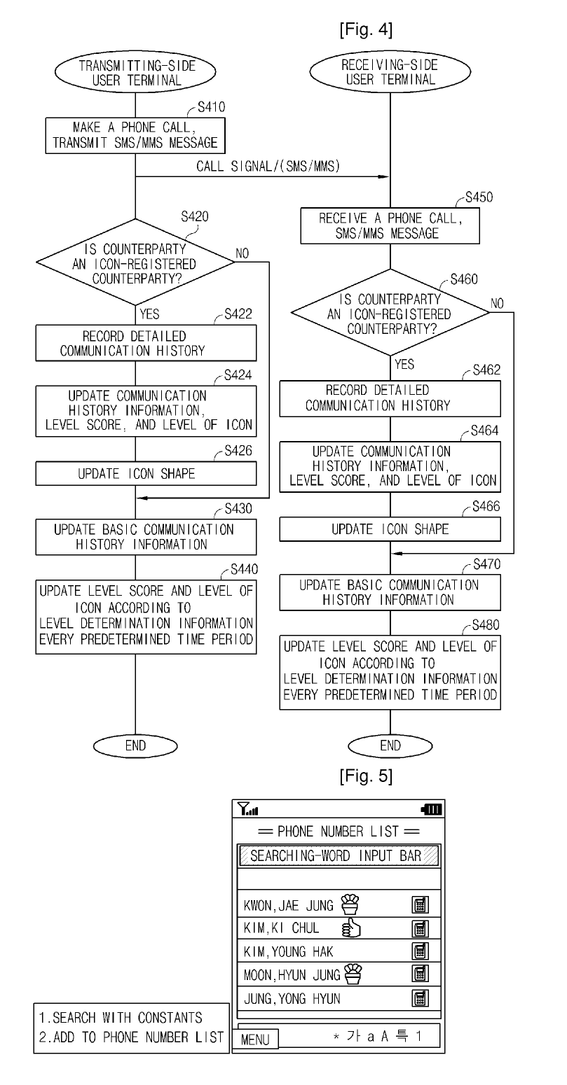

FIG. 4 is a flowchart illustrating processes of an icon management method according to the preferred embodiment of the present invention in a case where the user terminal is a mobile communication terminal.

Referring to FIG. 4, a method of displaying a communication amount of each user implemented in a mobile communication terminal is described. Firstly, a transmitting-side user terminal makes a phone call to a receiving-side user terminal to transmit an SMS or MMS message (S410). The transmitting-side user terminal checks whether or not an icon of the counterparty who is to receive the phone call or the message is registered (S420). If the counterparty is a icon-registered counterparty, a detailed communication history of the counterparty is recorded (S422).

When the phone call is ended or the message transmission is ended, the transmitting-side user terminal updates the detailed communication history information, the level score, and the level included in the level determination information by using the communication history recorded in the step S422 (S424) and displays the icon shape corresponding to the level of icon beside the phone number of the counterparty to update the icon shape (S426).

As a result of the checking in the step S420, if the icon of the call counterparty or the message receiving user is not registered or after the steps S422 to S426 are performed, the transmitting-side user terminal updates the basic communication history information (a total communication time amount, a total transmitting communication amount, and the like) of the mobile communication terminal (S430).

In addition, during the time that a phone call to the icon-registered user is not made, the user terminal updates and stores the level score and the level of icon every time period represented by the automatic update time period information. When the user searches the phone number list and the recent communication list, the user terminal displays the icon to the user according to the stored icon (S440).

The receiving-side user terminal receives the phone call or the SMS/MMS message from the transmitting-side user terminal (S450). The receiving-side user terminal checks whether or not the transmitting-side user is an icon-registered counterparty (S460).

As a result of the checking, if the user is not an icon-registered counterparty, the method proceeds to a step S470. If the user is an icon-registered counterparty, the detailed communication history thereof is recorded (S462). In addition, the receiving-side user terminal updates the detailed communication history information, the level score, and the level of icon included in the level determination information by using the communication history recorded in the step S462 and updates and displays the icon shape according to a change in the level of icon (S466).

The receiving-side user terminal updates the basic communication history information that is generally performed in a mobile communication terminal (S470).

In addition, during the time that a phone call to the icon-registered user is not made, the user terminal updates and stores the level score and the level of icon every time period represented by the automatic update time period information. When the user searches the phone number list and the recent communication list, the user terminal displays the icon to the user according to the stored icon (S480).

The steps S462 to S480 performed in the receiving-side user terminal are the same as the steps S422 to S440 performed in the transmitting-side user terminal, and thus, detailed description thereof is omitted.

FIGS. 5 to 8 are views illustrating an example of a method of displaying a communication amount of each user in a user terminal that is a mobile communication terminal.

Firstly, referring to FIG. 5, when the user searches the phone number list of the mobile communication terminal, the user terminal displays the phone number list one the display unit. If the counterparty is an icon-registered user, an icon is displayed beside of the name of the counterparty. In FIG. 5, a flower pot icon and a thumbs-up hand icon are illustrated. As described above, the display icons may be updated as a shape of withered flower or a shape of a thumbs-lowering hand according to the communication amount with respect to the user.

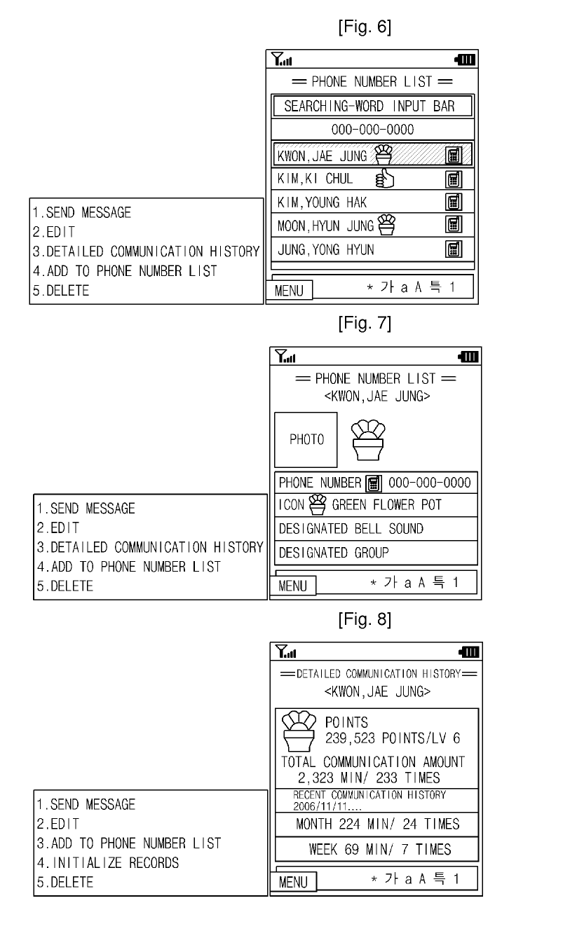

FIG. 6 illustrates an example where the user disposes a selection bar at a specific name in the phone number list, and FIG. 7 illustrates an example where the user selects the name at which the selection bar is disposed. When the user selects the specific name in the phone number list, as shown in FIG. 7, the user terminal displays basic information of the user such as a phone number, an icon name, and a designated bell sound and outputs a selection menu.

Next, when the user selects the detailed commutation history in the displayed menu, as shown in FIG. 8, the detailed communication history information such as a current level score, a level of icon, a total communication time amount, total communication times, a recent communication time amount, month-based communication time amount and times, and week-based communication time amount and times is output to the user.

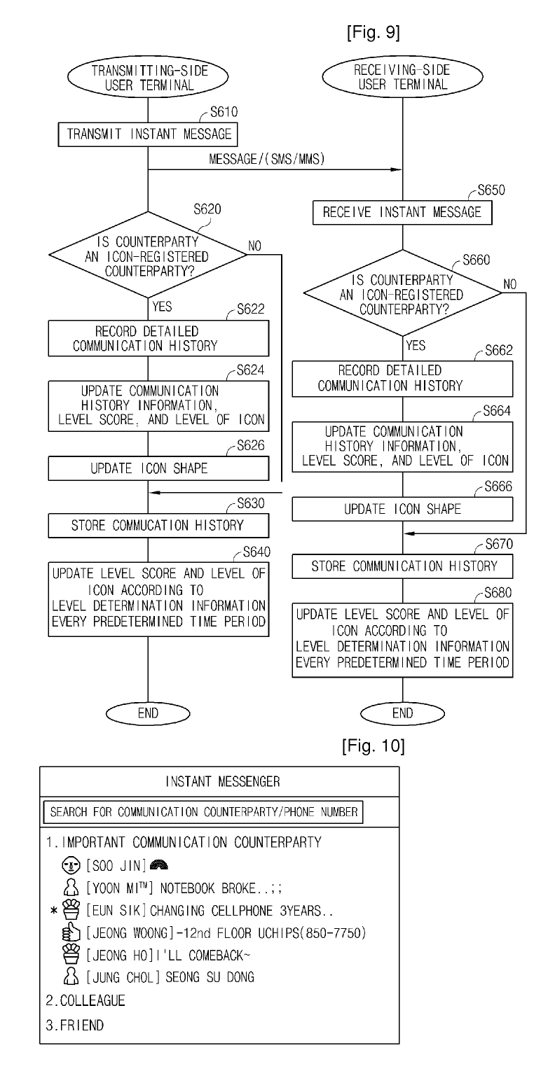

Hereinbefore, the example where the user terminal is a mobile communication terminal is described with reference to FIGS. 4 to 8. Hereinafter, an example where the user terminal is a computer with a messenger program installed therein will be described with reference to FIGS. 9 to 13.

FIG. 9 is a flowchart for explaining a method of displaying a communication amount of each user according to the present invention in a case where a user terminal is a computer with a messenger program installed therein. FIGS. 10 to 13 are views illustrating an example of a method of displaying a communication amount of each user in a user terminal that is a computer with a messenger program installed therein.

Firstly, referring to FIG. 9, the user drives the messenger program thereof, selects a specific counterparty in a messenger communication counterparty list, inputs an instant message, and transmits the instant message so as to start the communication (S610).

Next, the user terminal checks whether or not the icon of the communication counterparty is registered (S620). If the icon is not registered, the method proceeds to a step S630.

If the icon of the communication counterparty is registered, the user terminal records a detailed communication history (S622). At this time, although the communication history described with reference to FIG. 4 may be recorded, in most case, the messenger communication is not a continuous real-time communication but an intermittent communication on a messenger window, so that the communication history information is calculated from the communication times or transmitting/receiving communication data amount.

When the communication is ended, the user terminal updates the detailed communication history information, the level score, and the level of icon include in the level determination information by using the communication history recorded in the step S622 (S624). If the level of icon is changed, the icon shape is changed into a shape corresponding to the level so as to update the icon shape (S626).

If the icon of the communication counterparty is not registered or after the steps S622 to S626 are performed, the user terminal stores the communication history according to predetermined settings of the user (S630).

In addition, during the time that a phone call to the icon-registered user is not made, the user terminal updates and stores the level score and the level of icon every time period represented by the automatic update time period information. When the user searches the communication counterparty list, the user terminal displays the icon to the user according to the stored icon (S640).

The receiving-side user terminal receives the instant message and displays the instant message to the user (S650). The receiving-side user terminal checks whether or not the counterparty who transmits the instant message is an icon-registered counterparty (S660) and records the detailed communication history (S662). The receiving-side user terminal updates the detailed communication history information, the level score, and the level of icon by using the recorded communication history (S664). In addition, the receiving-side user terminal updates the icon shape according to the update level of icon (S666). The steps S662 to S666 are substantially the same as the steps S622 to S626, and thus, detailed description is omitted.

If the icon of the communication counterparty is not registered or after the steps S662 to S666 are performed, the user terminal stores the communication history according to predetermined settings of the user (S670).

In addition, during the time that a phone call to the icon-registered user is not made, the user terminal updates and stores the level score and the level of icon every time period represented by the automatic update time period information. When the user searches the communication counterparty list, the user terminal displays the icon to the user according to the stored icon (S680).

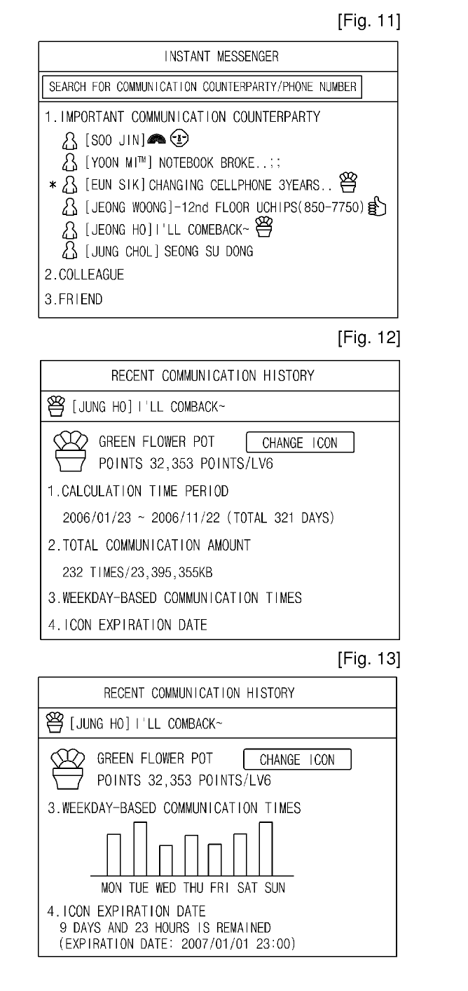

FIGS. 10 and 11 illustrate examples where the user ID and the icon are displayed in the messenger communication counterparty list. As shown in the figures, the icon may be displayed in front or behind the registered user ID.

FIGS. 12 and 13 illustrate detailed communication history information of a specific communication counterparty selected by a user. As shown in FIGS. 12 and 13, the user terminal can provides the icon shape, the level score, the level of icon, a communication history information calculation time period, total communication times and communication amount, weekday-based communication times, icon expiration date as the detailed communication history information.

Hereinbefore, a method of displaying a communication amount of each user by using an icon according to the preferred embodiments of the present invention and a communication terminal using the method are described. The embodiments are provided as exemplary ones, but various modifications can be made within the scope of the present invention. For example, although one-side user purchases an icon and transmits the icon to the other-side user in the aforementioned embodiments, the one-side user may directly access the icon providing server to purchase the icon and install the icon in the communication terminal thereof. In this case, the user downloads and executes the icon management program and registers the icon by designating a counterparty stored in the communication terminal thereof.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A communication terminal comprising:
a display unit which displays a list of communication counterparties together with an icon of an icon-registered communication counterparty among the communication counterparties in the list;
a storage unit which stores registered-icon identification information of the communication counterparty, image information of each level of icon, level determination information for defining a level determination scheme for the icon, and detailed communication history information representing a communication amount to the communication counterparty; and
a central controller which determines the level of icon according to the level determination information and the communication amount transmitted/received to/from a user terminal of the communication counterparty and outputs the image information of the icon corresponding to the level of icon to the display unit.

2. The communication terminal according to claim 1,
wherein the central controller updates the detailed communication history information according the communication amount transmitted/received from/to the user terminal of the communication counterparty and stores the detailed communication history information to the storage unit,
wherein the central controller determines the level of icon by using the detailed communication history information and stores the level of icon, and
wherein the central controller outputs the image information of the icon corresponding to the level of icon to the display unit.

3. The communication terminal according to claim 2,
wherein the level determination information defines the level determination scheme for the icon by using the detailed communication history information, and
wherein the central controller calculates a level score by allocating different scores to a communication data received from the user terminal of the communication counterparty and a communication data transmitted to the user terminal of the communication counterparty according to the level determination information and determines the level of icon according to the level score.

4. The communication terminal according to claim 2,
wherein the level determination information defines the level determination scheme for the icon by using the detailed communication history information, and
wherein the central controller calculates a level score by allocating different scores to a phone communication data, an SMS message, an MMS message, and an instant message received/transmitted from/to the user terminal of the communication counterparty according to the level determination information and determines the level of icon according to the level score.

5. The communication terminal according to claim 1,
wherein the detailed communication history information includes at least one of a total number of communication times, a total number of transmitting times, a total number of receiving times, total communication time amount, a total transmitting time amount, a total receiving time amount, a recent transmitting date, a recent receiving date, weekday/week/month-based communication times and communication amount, and existence of transmitting/receiving history with respect to the communication counterparty, and
wherein the central controller outputs to the display unit the detailed communication history information in accordance with user's selection.

6. The communication terminal according to claim 1, wherein the central controller updates the communication amount with respect to the icon-registered communication counterparty according to an automatic update time period information included in the level determination information, updates the level of icon according to the updated communication amount, and displays icon image information corresponding to the updated level of icon to the user.

7. A method of displaying a communication amount of each user on a communication terminal implemented with a mobile communication terminal or a computer, the method comprising steps of:
(a) registering an icon of which shape is changed according to the communication amount with respect to the communication counterparty in a phone number list or a communication counterparty list registered in the communication terminal;
(b) performing communication by transmitting a phone call or a predetermined-format message to a user terminal of the communication counterparty or receiving the phone call or the predetermined-format message from the user terminal of the communication counterparty;
(c) recording a communication history with respect to the communication counterparty and updating detailed communication history information with respect to the communication counterparty to determine a level of icon; and
(d) displaying an icon image having a shape corresponding to the level of icon to the user.

8. The method according to claim 7,
wherein the detailed communication history information includes at least one of a total number of communication times, a total number of transmitting times, a total number of receiving times, total communication time amount, a total transmitting time amount, a total receiving time amount, a recent transmitting date, a recent receiving date, weekday/week/month-based communication times and communication amount, and existence of transmitting/receiving history with respect to the communication counterparty, and
wherein in the step (c), a predetermined score is allocated to each item in the detailed communication history information to calculate a level score, and the level of icon is determined according to the level score.

9. The method according to claim 7, wherein in the step (c), different scores are allocated to different types of a communication data received from a user terminal of the communication counterparty and a communication data transmitted to the user terminal of the communication counterparty to calculate the level score, and the level of icon is determined according to the level score.

10. The method according to claim 7,
wherein the detailed communication history information includes at least one of a total number of communication times, a total number of transmitting times, a total number of receiving times, total communication time amount, a total transmitting time amount, a total receiving time amount, a recent transmitting date, a recent receiving date, weekday/week/month-based communication times and communication amount, and existence of transmitting/receiving history with respect to the communication counterparty, and
wherein the method further comprises a step of outputting to the user the detailed communication history information in accordance with user's selection.

11. The method according to claim 7, wherein in the step (a), icon-level-based image information, level determination information for defining an icon level determination scheme and a level update time period, and identification information for representing a communication counterparty to which the icon is registered are downloaded from a predetermined icon providing server, and the icon of the counterparty represented by the identification information is registered.

12. The method according to claim 11, further comprising a step of updating the level of icon according to the level determination information every level update time period.

13. A method of displaying a communication amount of each user, the method comprising steps of:
a first user terminal accessing a predetermined icon providing server, selecting an icon which is to be transmitted to a second user terminal, and completing payment for the icon;
the icon providing server downloading to the second user terminal the icon selected by the first user terminal together with identification information of the first user terminal;
the second user terminal identifying the first user according to the identification information and registering the icon in association with the first user;
the second user terminal recording a communication history and updating detailed communication history information during communication with the first user terminal; and
the second user terminal updating the level of icon according to the detailed communication history information and displaying to the second user the icon having a shape corresponding to the level of icon in association with the first user.

14. The method according to claim 13, further comprising a steps of updating the detailed communication information every predetermined time period, updating and storing the level of icon according to the detailed communication history information, and displaying the second user the icon having a shape corresponding to the updated level of icon in association with the first user.

15. A computer-readable recording medium having the method according to claim 7, recorded thereon as a computer-executable program code.

16. The communication terminal according to claim 2, wherein the central controller updates the communication amount with respect to the icon-registered communication counterparty according to an automatic update time period information included in the level determination information, updates the level of icon according to the updated communication amount, and displays icon image information corresponding to the updated level of icon to the user.

17. The communication terminal according to claim 3, wherein the central controller updates the communication amount with respect to the icon-registered communication counterparty according to an automatic update time period information included in the level determination information, updates the level of icon according to the updated communication amount, and displays icon image information corresponding to the updated level of icon to the user.

18. The communication terminal according to claim 4, wherein the central controller updates the communication amount with respect to the icon-registered communication counterparty according to an automatic update time period information included in the level determination information, updates the level of icon according to the updated communication amount, and displays icon image information corresponding to the updated level of icon to the user.

19. The communication terminal according to claim 5, wherein the central controller updates the communication amount with respect to the icon-registered communication counterparty according to an automatic update time period information included in the level determination information, updates the level of icon according to the updated communication amount, and displays icon image information corresponding to the updated level of icon to the user.

20. A computer-readable recording medium having the method according to claim 8, recorded thereon as a computer-executable program code.

21. A computer-readable recording medium having the method according to claim 9, recorded thereon as a computer-executable program code.

22. A computer-readable recording medium having the method according to claim 10, recorded thereon as a computer-executable program code.

23. A computer-readable recording medium having the method according to claim 11, recorded thereon as a computer-executable program code.

24. A computer-readable recording medium having the method according to claim 12, recorded thereon as a computer-executable program code.

25. A computer-readable recording medium having the method according to claim 13, recorded thereon as a computer-executable program code.

26. A computer-readable recording medium having the method according to claim 14, recorded thereon as a computer-executable program code.
